(19) United States
(12) Patent Application Publication
(10) Pub. No.: US 2014/0330643 A1
(43) Pub. Date: Nov. 6, 2014

(54) Automatically Determining Relationships between Mobile Devices

(71) Applicant: ADMOBIUS, INC., San Mateo, CA (US)

(72) Inventors: Dan Grigorovici, Pleasanton, CA (US); Omar Abdala, Palo Alto, CA (US); Hao Duong, Castro Valley, CA (US); Melissa Stein, Menlo Park, CA (US)

(73) Assignee: AdMobius, Inc., San Mateo, CA (US)

(21) Appl. No.: 13/886,187

(22) Filed: May 2, 2013

(51) Int. Cl. G06Q 30/02

(52) U.S. Cl. CPC G06Q 30/0267; G06Q 30/0254; G06Q 30/0255
USPC 705/14.52; 705/14.64; 705/14.53

(57) ABSTRACT

Relationships between a plurality of mobile devices are automatically determined. For each mobile device in the plurality of mobile devices, characteristics of a user of the mobile device are determined. Based on the characteristics of the users of the mobile devices, a first role of a first user of a first mobile device is determined. Based on the characteristics of the users of the mobile devices, a second role of a second user of a second mobile device is determined. Based on the first role and the second role, a relationship between the first user and the second user is determined. A determination is made that a relationship between the first mobile device and the second mobile device is equal to the relationship between the first user and the second user.

### BACKGROUND

1. Technical Field

The present invention generally relates to the field of data analysis and, in particular, to automatically determining relationships between mobile devices.

2. Background Information

People who share an important trait, such as being members of the same household or the same workplace, can be clustered into a group. People in the same group are connected by relationships (e.g., familial relationships in a household group and collegial relationships in a workplace group). These relationships can be extended to the mobile devices used by these people (e.g., tablet computers and smartphones). Knowing the relationships between the mobile devices in a group (i.e., the relationships between the devices' users) benefits mobile advertising and mobile content. For instance, the transmission of targeted advertising messages or targeted content within a group can be based on the role of that device within the group (i.e., the role of that device's user).

### SUMMARY

The above and other issues are addressed by a method, non-transitory computer-readable storage medium, and system for automatically determining relationships between a plurality of mobile devices. An embodiment of the method comprises determining, for each mobile device in the plurality of mobile devices, characteristics of a user of the mobile device. The method further comprises determining, based on the characteristics of the users of the mobile devices, a first role of a first user of a first mobile device. The method further comprises determining, based on the characteristics of the users of the mobile devices, a second role of a second user of a second mobile device. The method further comprises determining, based on the first role and the second role, a relationship between the first user and the second user. The method further comprises determining that a relationship between the first mobile device and the second mobile device is equal to the relationship between the first user and the second user.

An embodiment of the medium stores executable computer program instructions for automatically determining relationships between a plurality of mobile devices. The instructions determine, for each mobile device in the plurality of mobile devices, characteristics of a user of the mobile device. The instructions further determine, based on the characteristics of the users of the mobile devices, a first role of a first user of a first mobile device. The instructions further determine, based on the characteristics of the users of the mobile devices, a second role of a second user of a second mobile device. The instructions further determine, based on the first role and the second role, a relationship between the first user and the second user. The instructions further determine that a relationship between the first mobile device and the second mobile device is equal to the relationship between the first user and the second user.

An embodiment of the system for automatically determining relationships between a plurality of mobile devices comprises at least one non-transitory computer-readable storage medium storing executable computer program instructions. The instructions comprise instructions for determining, for each mobile device in the plurality of mobile devices, characteristics of a user of the mobile device. The instructions further determine, based on the characteristics of the users of the mobile devices, a first role of a first user of a first mobile device. The instructions further determine, based on the characteristics of the users of the mobile devices, a second role of a second user of a second mobile device. The instructions further determine, based on the first role and the second role, a relationship between the first user and the second user. The instructions further determine that a relationship between the first mobile device and the second mobile device is equal to the relationship between the first user and the second user.

### BRIEF DESCRIPTION OF THE DRAWINGS

FIG. 1 is a high-level block diagram illustrating an environment for automatically determining relationships between mobile devices, according to one embodiment.

FIG. 2 is a high-level block diagram illustrating an example of a computer for use as one or more of the entities illustrated in FIG. 1, according to one embodiment.

FIG. 3 is a flowchart illustrating a method of automatically determining relationships between mobile devices, according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

Knowing the relationships between the mobile devices in a group (i.e., the relationships between the devices' users) presents opportunities for targeting advertising and targeted content displayed in the course of using the mobile devices (e.g., tablet computers and/or smartphones). For instance, the transmission of targeted advertising messages or targeted content within a group can be based on the role of that device within the group (i.e., the role of that device's user). The advertising messages or content sent to each device based on the relationship of the device to another device can reinforce the advertiser's or content provider's overall message. Combining the known relationship between devices with location and time further presents opportunities to increase the relevancy of the advertising or content shown.

Relationships between mobile devices can be used for split device marketing campaigns with messages and/or content aimed at the particular user based on the relationship with another user or device. For example, consider a split device marketing campaign for a movie that is intended to be marketed to mothers and daughters. The campaign could use two different messages—one for mothers that emphasizes details of the plot and another for daughters that emphasizes the presence of the teen heartthrob. In another example, consider a split device marketing campaign for a customer relationship software application that is intended to be marketed to businesses. The campaign could use four different messages—one for members of a Product department that emphasizes the software's ability to manage customer feedback, one for members of a Sales department that emphasizes the software's ability to track a sales pipeline, one for members of a Finance department that emphasizes the software's ability to forecast revenue, and one for members of an IT department that emphasizes the software's ease of installation. In general, knowing the roles of mobile devices within the same group and the relationships between them enables the delivery of appropriately tailored messages and/or content to those devices.

Note that before the relationships between the mobile devices can be determined, the mobile devices must first be clustered into groups believed to share an important trait, such as household or workplace. In one embodiment, this clustering is performed by analyzing advertisement request logs (including Internet Protocol (IP) addresses, timestamps, and Global Positioning System (GPS) coordinates) and auxiliary information (such as census information on GPS coordinates of neighborhood blocks and street segments, credit bureau listings of households and businesses, and IP address lists of Internet Service Providers (ISPs) and mobile provider gateways and locations). Various techniques can be used to produce the clusters of devices. These techniques include, for example, locality-sensitive hashing of user logs (to find proximal devices) and time-/location-based agglomerative clustering of devices into groups. In one embodiment, the features used in determining the multi-dimensional radius of a cluster include density of household/business listings in an area, frequency of network-wide IP address usage, and time and day of mobile usage.

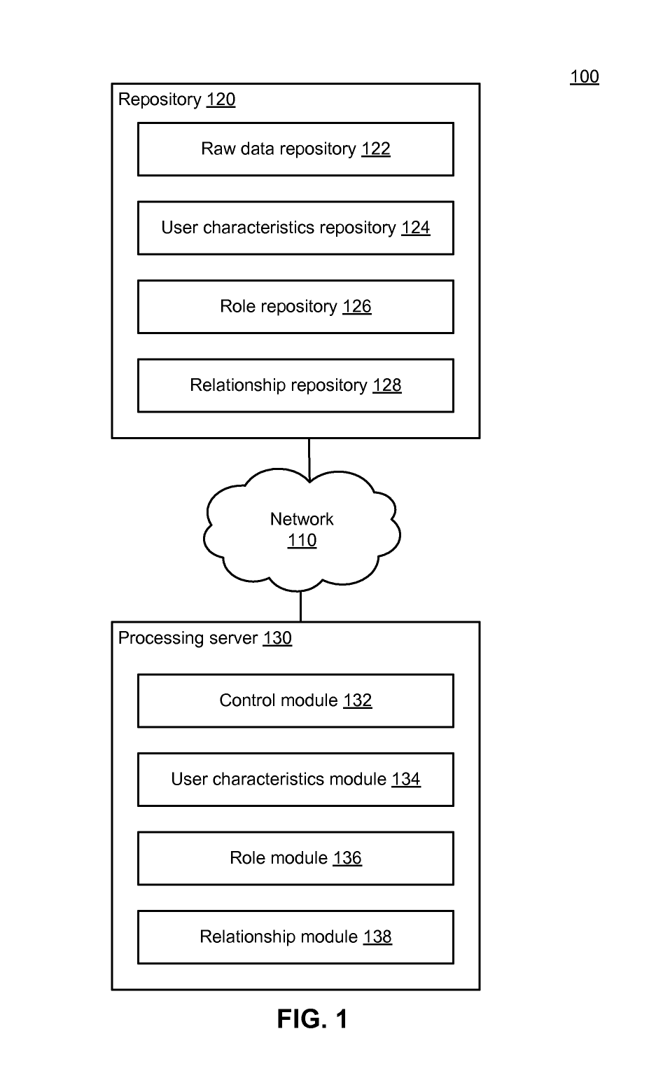

FIG. 1 is a high-level block diagram illustrating an environment 100 for automatically determining relationships between mobile devices according to one embodiment. The environment 100 may be maintained by an enterprise that determines relationships between mobile devices, such as a corporation, university, or government agency. As shown, the environment 100 includes a network 110, a repository 120, and a processing server 130. While only one of each entity is shown in the embodiment depicted in FIG. 1 for clarity, other embodiments can have multiple repositories 120 and/or processing servers 130.

The network 110 represents the communication pathway between the repository 120 and the processing server 130. In one embodiment, the network 110 uses standard communications technologies and/or protocols and can include the Internet. Thus, the network 110 can include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 110 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), etc. The data exchanged over the network 110 can be represented using technologies and/or formats including image data in binary form (e.g. Portable Network Graphics (PNG)), hypertext markup language (HTML), extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the entities on the network 110 can use custom and/or dedicated data communications technologies instead of, or in addition to, the ones described above.

The repository 120 is a computer (or set of computers) that stores a raw data repository 122, a user characteristics repository 124, a role repository 126, and a relationship repository 128. In one embodiment, the repository 120 includes a server that provides the processing server 130 access to the raw data repository 122, the user characteristics repository 124, the role repository 126, and the relationship repository 128 in response to requests.

The raw data repository 122 stores information that is relevant to determining the characteristics of a user of a mobile device. In one embodiment, the raw data repository 122 stores information regarding device-level characteristics and log data regarding application and/or content usage. Information stored in the raw data repository 122 is associated with a particular device, represented by a unique identifier (uniqueID).

Information regarding device-level characteristics includes, for example, make of the device, model of the device, operating system installed on the device, applications installed on the device, connection type used by the device, and connection IP address used by the device. Log data regarding application and/or content usage includes, for example, name of application, timestamp, device location (e.g., latitude/longitude using GPS), IP address communicated with, frequency of user interaction, user actions (e.g., views, clicks, or downloads), search terms entered by the user, referring uniform resource locators (URLs), and content consumed (e.g., the content's URL).

The user characteristics repository 124 stores characteristics of mobile device users. Characteristics of a mobile device user can be based on that user's demographics and/or behaviors. In one embodiment, a user's characteristics include only a demographic estimate. In another embodiment, a user's characteristics include only a set of one or more behavioral segments. In yet another embodiment, a user's characteristics include both a demographic estimate and a set of one or more behavioral segments. User characteristics stored in the user characteristics repository 124 are associated with a particular mobile device, represented by a unique identifier (uniqueID).

In one embodiment, a demographic estimate of a mobile device user includes dimensions such as gender, age, ethnicity, and/or household income (HHI). A demographic dimension is divided into classes of interest. For example, the gender dimension is divided into 2 classes (Male, Female), the age dimension can be divided into 7 classes (<18, 18-24, 25-34, 35-44, 45-54, 55-64, 65+), the ethnicity dimension can be divided into 4 classes (Asian, Black, Latino, White), and the HHI dimension can be divided into 4 classes (<$50K, $50-100K, $100-150K, $150+K).

In one embodiment, a demographic estimate includes no more than one class for a single dimension. In another embodiment, a demographic estimate can include multiple classes for a single dimension. In that embodiment, demographics are summarized as a probability distribution for each demographic dimension over the classes of interest. For example, a demographic estimate can include 2 classes for the gender dimension, where the Male class is associated with a 0.3 value (30% chance that the device user is male) and the Female class is associated with a 0.7 value (70% chance that the device user is female).

A behavioral segment of a mobile device user describes the user based on the user's behavior (e.g., application and/or content usage) and grades a mobile device in terms of recency, frequency, and/or volume of use of content of a particular type. Behavioral segments can include, for example, Entertainment Buff, Tech Maven, Business Traveler, and Business Decision Maker. These behavioral segments are further described below with reference to the user characteristics module 134. In one embodiment, a behavioral segment can be ranked according to quantity of use. For example, a behavioral segment label can be accompanied by a score that indicates how similar the device is to a prototypical member of that segment.

The role repository 126 stores roles of mobile device users. A role stored in the role repository 126 is associated with a particular device, represented by a unique identifier (uniqueID). Examples of roles within a household group include, for example, Head of Household (HOH), Parent, Father, Mother, Child, Son, and Daughter. Examples of roles within a workplace group include, for example, Product, Sales, Finance, Information Technology (IT), and other work functions.

The relationship repository 128 stores relationships between mobile device users. A generic (i.e., non-device-specific) relationship is represented as a tuple of roles. For example, a generic relationship within a household group could be: the spousal relationship defined as a pair (2-tuple) of the roles <Father, Mother>; the parental relationship defined as a pair of the roles <Father, Son>, <Father, Daughter>, <Mother, Son>, and <Mother, Daughter>; and the sibling relationship defined as a pair of the roles <Son, Son>, <Daughter, Daughter>, and <Son, Daughter>. A generic relationship can also be an n-tuple where n is greater than 2. For example, a generic relationship within a workplace group could be defined as a triple (3-tuple) of the roles <Product, Finance, Sales>.

A relationship between particular mobile device users is represented as a tuple of devices, where a device is represented by a unique identifier (uniqueID). Specifically, particular devices within a particular group (e.g., a household or a workplace) have been assigned roles. These roles “match” the roles in a generic relationship tuple. In one embodiment, each generic relationship is associated with a unique identifier. In this embodiment, each device-specific relationship is associated with a generic relationship identifier and a tuple of device uniqueIDs that match the identified generic relationship.

The processing server 130 includes various modules such as a control module 132 for determining relationships between mobile devices, a user characteristics module 134 for determining user characteristics, a role module 136 for determining roles, and a relationship module 138 for determining relationships. In one embodiment, the processing server 130 includes a computer (or set of computers) that communicates with repository 120 and processes data (e.g., by executing the control module 132, the user characteristics module 134, the role module 136, and the relationship module 138).

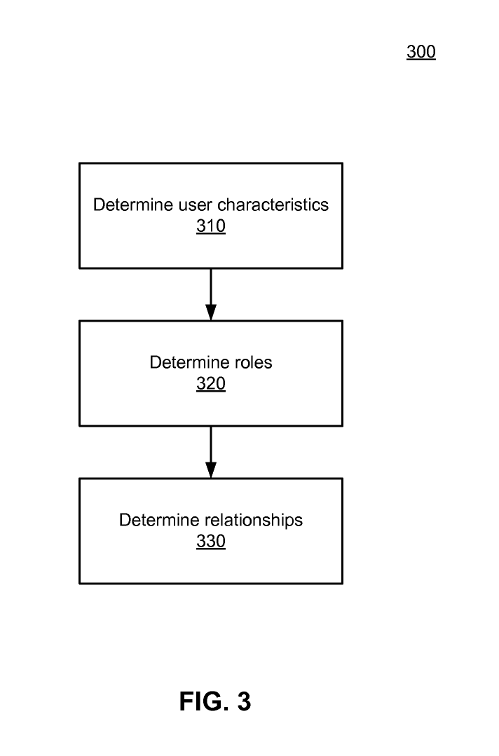

In general, the control module 132 determines relationships between mobile devices based on the contents of the raw data repository 122. The control module 132 will be discussed below with reference to FIG. 3.

The user characteristics module 134 determines characteristics of mobile device users. Recall that a user's characteristics include a demographic estimate and/or a set of one or more behavioral segments. The user characteristics module 134 takes as input information that is relevant to determining the characteristics of the user of a device and outputs characteristics of that device user. The user characteristics module 134 analyzes the input information for clues about user characteristic features. This analysis can include determining application usage trends and patterns, such as the type, frequency, and time of application usage. Also, multiple attributes can be correlated to determine a pattern of device usage. These attributes can include, for example, context, interests, and local household/business information.

For example, regarding the gender dimension of a demographic estimate, males and females typically have different usage patterns. Heavy usage of fantasy football applications is an indicator of a male, whereas usage of everyday-health applications is an indicator of a female. As another example, a device that frequently consumes a large volume of entertainment might be labeled with the “Entertainment Buff” behavioral segment. A device with similar usage of technology content might be labeled with the “Tech Maven” behavioral segment. A third example of a behavioral segment is a trait inferred based on the device's usage history. For example, the GPS history and IP history of a device generally indicate a user's home zone. Frequency of travel outside of such a home zone during business hours can be a marker of business travel, which would cause the device to be labeled with the “Business Traveler” behavioral segment.

In one embodiment, user characteristics module 134 executes multiple predictors for a single demographic dimension. A predictor estimates a deviation from a prior probability of the device user being in a particular class. Alternatively, user characteristics module 134 uses multiple models for a single demographic dimension. A model estimates a probability distribution for the demographic dimension over the classes of interest. Each model yields a probability distribution, and the distributions are combined into one estimate of the probability distribution over the classes of the dimension of interest.

The types of models include, for example, application usage models, latitude/longitude/time-based estimates, device model information, and volume of use information. Regarding application usage models, it is possible to determine what demographic is implied by a given level of use on each application and then apply these estimates back to particular devices. Regarding latitude/longitude/time-based estimates, it is possible to determine the dimension class associated with residing in a particular location, use latitude/longitude to estimate the block in which a device “resides”, and then apply aggregate statistics on the dimension (e.g., HHI). Regarding device model information, the recency of the purchase and the price of the device can be relevant (e.g., to HHI). Regarding volume of use information, how much overall data the device is consuming can be relevant (e.g., to HHI). The models can use various algorithms, such as naïve Bayes, k-Nearest Neighbor (k-NN), classification tree, support vector machines (SVMs), k-means clustering, and canopy clustering.

The role module 136 determines roles of mobile device users. The role module 136 takes as input characteristics of device users within a particular group (e.g., household or workplace) and outputs roles for those device users within that group. In one embodiment, the role module 136 uses an expected demographic profile for a role. For example, the role of “Father” has an expected demographic profile of [Male=1.0, Female=0.0] for the gender dimension and [18-24=0.0, 25-34=0.25, 35-44=0.4, 45-54=0.25, 55-64=0.1, 65+=0.0] for the age dimension. The role of “Mother” has a similar expected demographic profile, except that the gender vector is the opposite ([Male=0.0, Female=1.0]). In one embodiment, the expected demographic profiles are empirically selected.

In one embodiment, roles within a mobile device group (e.g., household or workplace) are assigned as follows: The demographic estimates of the device users in the group are compared to the expected demographic profiles. Measures of similarity are determined between the expected demographic profile and the demographic estimates. The device user that matches the expected demographic profile most strongly is assigned with that role. In one embodiment, the expected demographic profiles and the demographic estimates are expressed as vectors. In that embodiment, the measure of similarity is a dot product of the demographics vector and the expected demographic profile vector.

In another embodiment, a role is assigned based on membership in a device group in combination with a behavioral segment. For example, a mobile device user who has been assigned the behavioral segment of “Tech Maven” in a workplace can be assigned the role of “Product” for that workplace. As another example, a mobile device user who has been assigned the behavioral segment of “Business Decision Maker” in a workplace can be assigned the role of “Finance” for that workplace. As yet another example, a mobile device user who has been assigned the behavioral segment of “Business Traveler” in a workplace can be assigned the role of “Sales” for that workplace. Note that multiple devices in the same device group can be assigned the same role. For example, multiple devices can match the “IT” profile, since it is likely that multiple devices are used by people in the IT department. In this situation, multiple devices would be assigned the “IT” role.

The relationship module 138 determines relationships between mobile device users. The relationship module 138 takes as input roles of device users within a particular group (e.g., household or workplace) and outputs relationships for those device users within that group. Recall that generic household relationship examples include spousal, parental, and sibling. The relationship module 138 determines the relationship between particular mobile device users based on generic relationships and the roles assigned to those particular mobile device users, as described above.

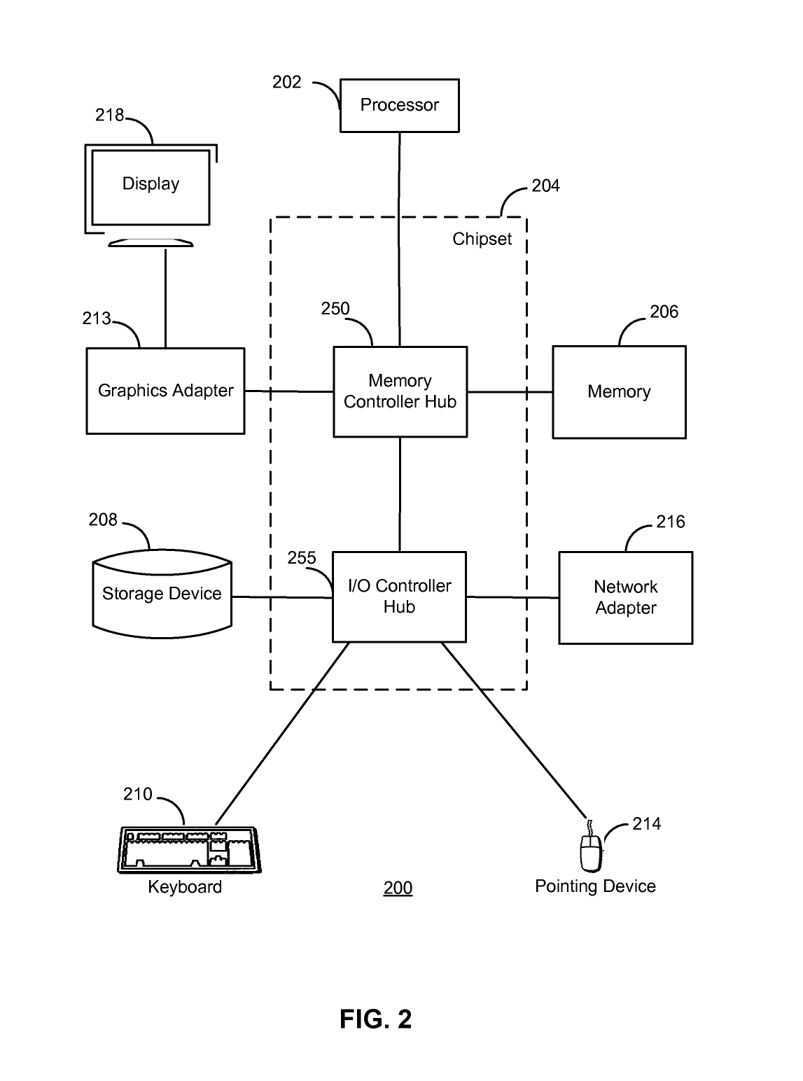

FIG. 2 is a high-level block diagram illustrating an example of a computer 200 for use as a repository 120 and/or a processing server 130, in accordance with one embodiment. Illustrated are at least one processor 202 coupled to a chipset 204. The chipset 204 includes a memory controller hub 250 and an input/output (I/O) controller hub 255. A memory 206 and a graphics adapter 213 are coupled to the memory controller hub 250, and a display device 218 is coupled to the graphics adapter 213. A storage device 208, keyboard 210, pointing device 214, and network adapter 216 are coupled to the I/O controller hub 255. Other embodiments of the computer 200 have different architectures. For example, the memory 206 is directly coupled to the processor 202 in some embodiments.

The storage device 208 includes one or more non-transitory computer-readable storage media such as a hard drive, compact disk read-only memory (CD-ROM), DVD, or a solid-state memory device. The memory 206 holds instructions and data used by the processor 202. The pointing device 214 is used in combination with the keyboard 210 to input data into the computer system 200. The graphics adapter 213 displays images and other information on the display device 218. In some embodiments, the display device 218 includes a touch screen capability for receiving user input and selections. The network adapter 216 couples the computer system 200 to the network 110. Some embodiments of the computer 200 have different and/or other components than those shown in FIG. 2. For example, the repository 120 and/or the processing server 130 can be formed of multiple blade servers and lack a display device, keyboard, and other components.

The computer 200 is adapted to execute computer program modules for providing functionality described herein. As used herein, the term “module” refers to computer program instructions and/or other logic used to provide the specified functionality. Thus, a module can be implemented in hardware, firmware, and/or software. In one embodiment, program modules formed of executable computer program instructions are stored on the storage device 208, loaded into the memory 206, and executed by the processor 202.

FIG. 3 is a flowchart illustrating a method 300 of automatically determining relationships between mobile devices, according to one embodiment. Other embodiments can perform the steps in different orders and can include different and/or additional steps. In addition, some or all of the steps can be performed by entities other than those shown in FIG. 1.

When the method 300 starts, mobile devices have already been clustered into a group (e.g., household or workplace). Also, information that is relevant to determining the characteristics of users of those mobile devices within that group has already been stored in the raw data repository 122.

In step 310, characteristics are determined for the mobile device users within the group. For example, the control module 132 obtains information from the raw data repository 122, passes that information to the user characteristics module 134, and executes the user characteristics module 134. The control module 132 then stores the user characteristics, output by the user characteristics module 134, in the user characteristics repository 124.

In step 320, roles are determined for the mobile device users within the group. For example, the control module 132 obtains user characteristics from the user characteristics repository 124, passes the user characteristics to the role module 136, and executes the role module 136. The control module 132 then stores the roles, output by the role module 136, in the role repository 126.

In step 330, relationships are determined for the mobile device users within the group. For example, the control module 132 obtains roles from the role repository 126, passes the roles to the relationship module 138, and executes the relationship module 138. The control module 132 then stores the relationships, output by the relationship module 138, in the relationship repository 128. The control module 132 then uses the relationships stored in the relationship repository 128, which concern device users, as a proxy for relationships between those users' mobile devices.

The above description is included to illustrate the operation of certain embodiments and is not meant to limit the scope of the invention. The scope of the invention is to be limited only by the following claims. From the above discussion, many variations will be apparent to one skilled in the relevant art that would yet be encompassed by the spirit and scope of the invention.

1. A method for automatically determining relationships between a plurality of mobile devices, comprising:
determining, for each mobile device in the plurality of mobile devices, characteristics of a user of the mobile device;
determining, based on the characteristics of the users of the mobile devices, a first role of a first user of a first mobile device;
determining, based on the characteristics of the users of the mobile devices, a second role of a second user of a second mobile device;
determining, based on the first role and the second role, a relationship between the first user and the second user; and
determining that a relationship between the first mobile device and the second mobile device is equal to the relationship between the first user and the second user.

2. The method of claim 1, wherein the first mobile device comprises a tablet computer or a smartphone.

3. The method of claim 1, further comprising a preliminary step of grouping the plurality of mobile devices.

4. The method of claim 1, wherein the users of the plurality of mobile devices belong to a single household or a single workplace.

5. The method of claim 1, further comprising determining a first targeted advertising message to send to the first mobile device and a second targeted advertising message to send to the second mobile device based on the relationship between the first mobile device and the second mobile device.

6. The method of claim 1, wherein characteristics of a mobile device user include a demographic estimate of that user.

7. The method of claim 6, wherein the demographic estimate comprises one or more dimensions of a group containing gender, age, ethnicity, and household income.

8. The method of claim 6, wherein the demographic estimate comprises a probability distribution over classes of interest for a dimension.

9. The method of claim 1, wherein characteristics of a mobile device user include a behavioral segment determined based on that user's usage of an application or content.

10. The method of claim 9, wherein the behavioral segment grades the mobile device based on one or more elements of a group containing recency, frequency, and volume of use of content of a particular type.

11. The method of claim 1, wherein determining the characteristics of the user of the mobile device comprises analyzing device-level characteristics of the mobile device.

12. The method of claim 11, wherein device-level characteristics of the mobile device comprise one or more elements of a group containing a make of the mobile device, a model of the mobile device, an operating system installed on the mobile device, one or more applications installed on the mobile device, a connection type used by the mobile device, and a connection Internet Protocol (IP) address used by the mobile device.

13. The method of claim 1, wherein determining the characteristics of the user of the mobile device comprises analyzing log data regarding application usage or content usage of the mobile device.

14. The method of claim 13, wherein log data regarding application usage or content usage of the mobile device comprise one or more elements of a group containing a name of an application, a timestamp, a location of the mobile device, an IP address with which the mobile device communicated, a frequency of user interaction, one or more user actions, one or more search terms entered by the user of the mobile device, a referring uniform resource locator (URL), and content consumed.

15. The method of claim 1, wherein the first role comprises Head of Household, Parent, Father, Mother, Child, Son, or Daughter.

16. The method of claim 1, wherein the first role comprises Product, Sales, Finance, or Information Technology.

17. The method of claim 1, wherein determining, based on the characteristics of the users of the mobile devices, the first role of the first user of the first mobile device comprises:
for each mobile device in the plurality of mobile devices:
comparing an expected user characteristic profile for the first role to the characteristics of the user of the mobile device; and
determining a measure of similarity between the expected user characteristic profile and the characteristics of the user of the mobile device; and
assigning the first role to the user whose characteristics most strongly match the expected user characteristic profile.

18. The method of claim 17, wherein the expected user characteristic profile is expressed as a vector, the characteristics of the user of the mobile device are expressed as a vector, and determining the measure of similarity between the expected user characteristic profile and the characteristics of the user of the mobile device comprises calculating a dot product of the expected user characteristic profile vector and the user characteristics vector.

19. The method of claim 1, wherein the relationship between the first user and the second user comprises spousal, parental, or sibling.

20. A non-transitory computer-readable storage medium storing executable computer program instructions for automatically determining relationships between a plurality of mobile devices, the instructions performing steps comprising:
determining, for each mobile device in the plurality of mobile devices, characteristics of a user of the mobile device;
determining, based on the characteristics of the users of the mobile devices, a first role of a first user of a first mobile device;
determining, based on the characteristics of the users of the mobile devices, a second role of a second user of a second mobile device;
determining, based on the first role and the second role, a relationship between the first user and the second user; and
determining that a relationship between the first mobile device and the second mobile device is equal to the relationship between the first user and the second user.

21. A system for automatically determining relationships between a plurality of mobile devices, the system comprising:
at least one non-transitory computer-readable storage medium storing executable computer program instructions comprising instructions for:
determining, for each mobile device in the plurality of mobile devices, characteristics of a user of the mobile device;
determining, based on the characteristics of the users of the mobile devices, a first role of a first user of a first mobile device;
determining, based on the characteristics of the users of the mobile devices, a second role of a second user of a second mobile device;
determining, based on the first role and the second role, a relationship between the first user and the second user; and
determining that a relationship between the first mobile device and the second mobile device is equal to the relationship between the first user and the second user; and
a processor for executing the computer program instructions.
